(19) United States
(12) Patent Application Publication
(10) Pub. No.: US 2015/0129142 A1
(43) Pub. Date: May 14, 2015

(54) STRINGLESS CURTAIN STRUCTURE

(71) Applicant: Hua-Chi Huang, Changhua (TW)

(72) Inventor: Hua-Chi Huang, Changhua (TW)

(21) Appl. No.: 14/077,183

(22) Filed: Nov. 11, 2013

(51) Int. Cl. A47H 5/14; E06B 9/326; A47H 5/032; A47H 11/02; A47H 1/19; A47H 3/10

(52) U.S. Cl. CPC A47H 5/14; A47H 1/19; A47H 3/10; A47H 5/032; A47H 11/02; A47H 5/0325; E06B 9/326; E06B 2009/3265
USPC 160/370

(57) ABSTRACT

A stringless curtain structure has a curtain body, a string rolling mechanism and two breaking units, wherein weight of a spring in the string rolling mechanism and a weighted lower beam is balanced, the user can push/pull the weighted lower beam to control a curtain of the curtain body to eliminate the exposure of the string, so little children would not play with the string to lead to dangerous situation. Furthermore, the breaking unit is disposed at each sides of the string rolling mechanism, so when the curtain needs to be positioned, the friction between the string and the breaking units can be used to enhance the precision of the positioning of the curtain body.

### FIELD OF THE INVENTION

The present invention relates to a curtain structure, and more particularly to a stringless curtain structure.

### BACKGROUND OF THE INVENTION

Conventional curtains, such as Venetian blinds, roller blinds and Roman blinds are equipped with a string for the user to pull to control the movement of the curtain to provide shade, privacy and many other decorative purposes. However, the string of conventional curtains are usually of the shape of a closed circle and exposed outside the curtain, so when little children play near the curtain or play the string, the string is prone to entangle the child's neck to cause strangulation death. Therefore, there remains a need for a new and improved stringless curtain structure to overcome the problems stated above.

### SUMMARY OF THE INVENTION

The string of conventional curtains are usually of the shape of a closed circle and exposed outside the curtain, so when little children play near the curtain or play the string, the string is prone to entangle the child's neck to cause strangulation death.

To solve the problems stated above, the present invention provides a stringless curtain structure may include a curtain body, a string rolling mechanism and two breaking units. The curtain body has an upper beam having a receiving space, and a curtain is connected to a bottom portion of the upper beam, and a weighted lower beam is disposed at a bottom portion of the curtain. The string rolling mechanism has a base having a base receiving space, and a string rolling space is located on both sides of the base receiving space. A string opening is formed at an outer wall of the string rolling space, and a spring is disposed at the base receiving space of the base. Furthermore, a conjugating portion is formed at one side of the base receiving space to secure and position the spring. A gear is disposed at center of the spring through a shaft, and a rolling gear is disposed at each of the string rolling space, and one end of string is secured at the rolling gear. Surface of the rolling gear has a connecting gear to drive the gear and a driving gear, and a cover is provided to cover the base with the base receiving space and the string rolling space. Two breaking units are disposed on both sides of the receiving space of the upper beam, having at least three parallel staggered rods, so the string is configured to be twined in the breaking unit from the string rolling mechanism, connected with the curtain and secured at the weighted lower beam.

The present invention is advantageous because the weight of the spring and the weighted lower beam is balanced, the user can push/pull the weighted lower beam to control the curtain to eliminate the exposure of the string, so little children would not play with the string to lead to dangerous situation. Furthermore, the breaking unit is disposed at each sides of the string rolling mechanism, so when the curtain needs to be positioned, the friction between the string and the breaking units can be used to enhance the precision of the positioning of the curtain body.

### BRIEF DESCRIPTION OF THE DRAWINGS

FIG. 1 illustrates a three-dimensional structure of the present invention.

FIG. 2 illustrates an exploded view of the present invention.

FIG. 3 illustrates a schematic view of the curtain body in an open/close status in the present invention.

FIG. 4 illustrates a schematic view of the closed curtain with the inactive string rolling mechanism.

FIG. 5 illustrates an unfolded curtain in the present invention.

FIG. 6 illustrates a schematic view of the expanded curtain with the active string rolling mechanism.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

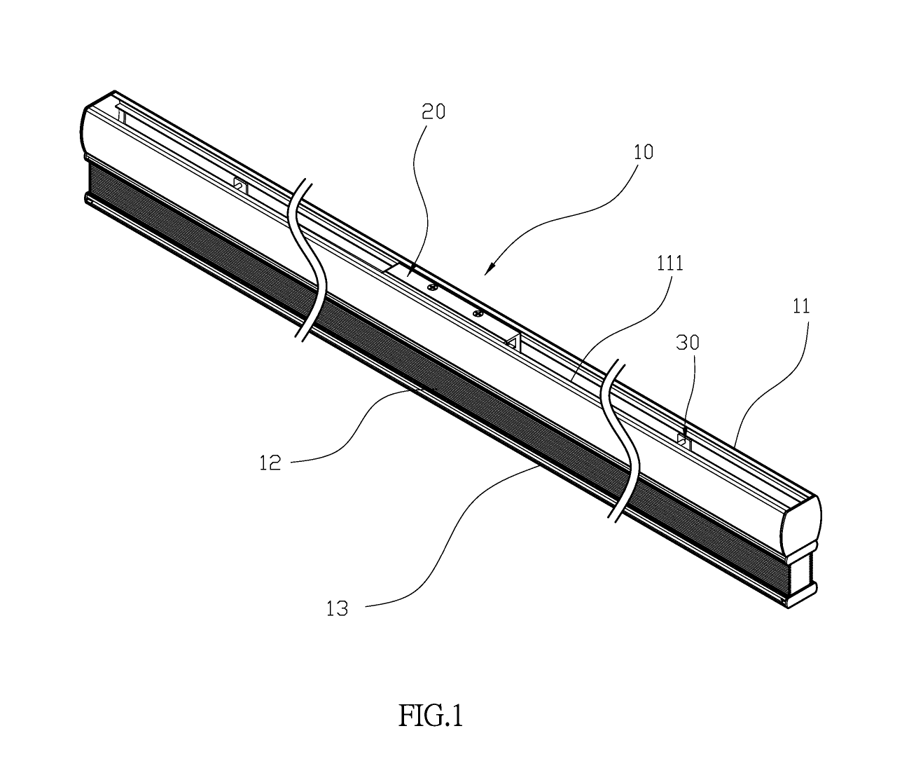

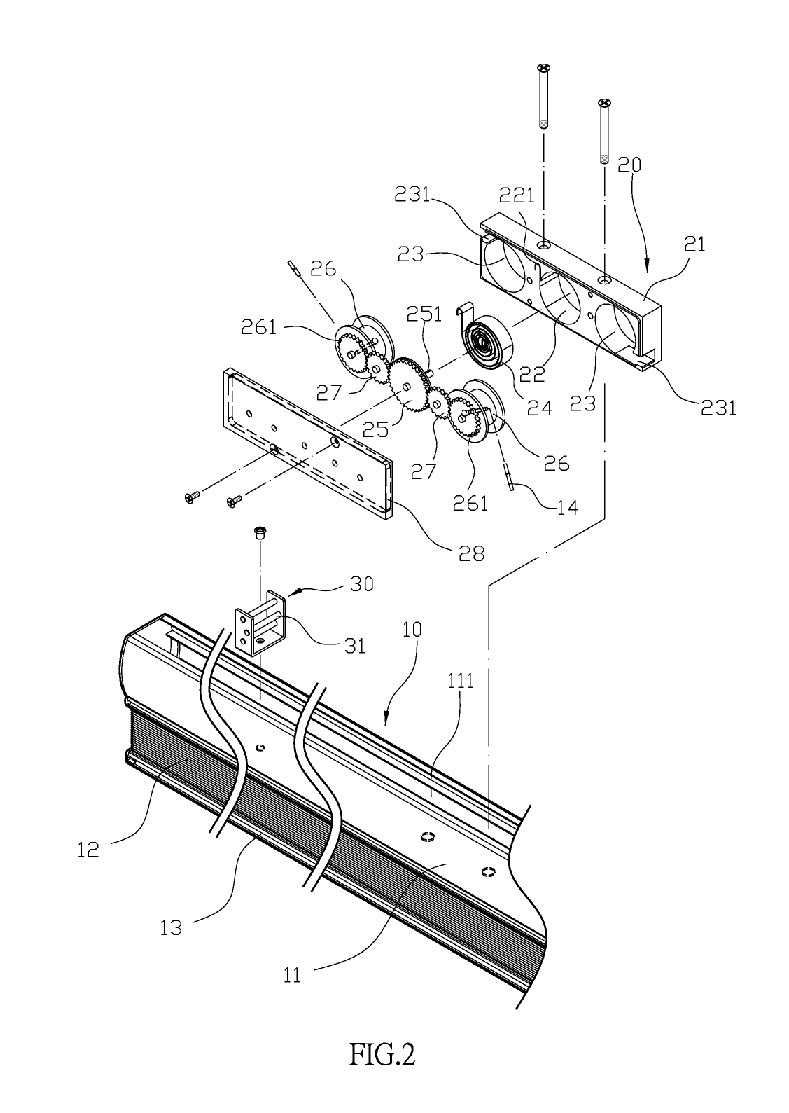

Referring to FIGS. 1 and 2, a stringless curtain structure may include a curtain body 10, a string rolling mechanism 20 and two breaking units 30. The curtain body 10 has an upper beam 11 having a receiving space 111, and a curtain 12 is connected to a bottom portion of the upper beam 111, and a weighted lower beam 13 is disposed at a bottom portion of the curtain 12. The string rolling mechanism 20 has a base 21 having a base receiving space 22, and a string rolling space 23 is located on both sides of the base receiving space 22. A string opening 231 is formed at an outer wall of the string rolling space 23, and a spring 24 is disposed at the base receiving space 22 of the base 21. Furthermore, a conjugating portion 221 is formed at one side of the base receiving space 22 to secure and position the spring 24. A gear 25 is disposed at center of the spring 24 through a shaft 251, and a rolling gear 26 is disposed at each of the string rolling space 23, and one end of string 14 is secured at the rolling gear 26. Surface of the rolling gear 26 has a connecting gear 261 to drive the gear 25 and a driving gear 27, and a cover 28 is provided to cover the base 21 with the base receiving space 22 and the string rolling space 23. Two breaking units 30 are disposed on both sides of the receiving space 111 of the upper beam 11, having at least three parallel staggered rods 31, so the string 14 is configured to be twined in the breaking unit 30 from the string rolling mechanism 20, connected with the curtain 12 and secured at the weighted lower beam 13.

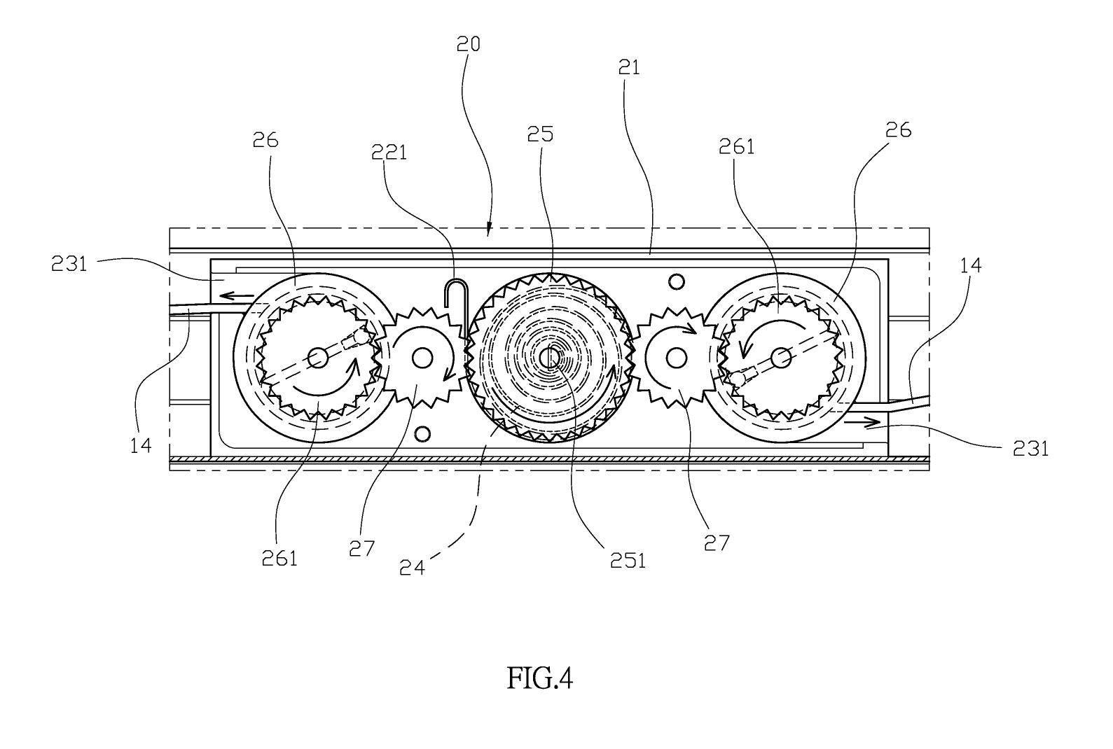

Referring to FIGS. 2 to 4 for the structure of the present invention, the curtain body 10 has the upper beam 11, curtain 12 and the weighted lower beam 13, and the receiving space 111 of the upper beam 11 has the string rolling mechanism 20 which has the breaking unit 30 on both sides thereof. The string rolling mechanism 20 has the base 21 that has the spring 24 and two rolling gears 26. One end of the spring 24 is secured at the conjugating portion 221, and the center portion of the spring 24 is connected to the gear 25. The string 14 is twined in the rolling gears 26, and one end of the string 14 is protruding out from the string opening 231 to twine between the staggered rods 31 of the breaking unit 30, and passes the upper beam 11 and the curtain 12 to secure at the weighted lower beam 13. The surface of the rolling gear 26 has the connecting gear 261 to drive the gear 25 and the driving gear 27, so the two rolling gears rotate in opposite directions. According to the structure stated above, a stringless curtain structure is formed.

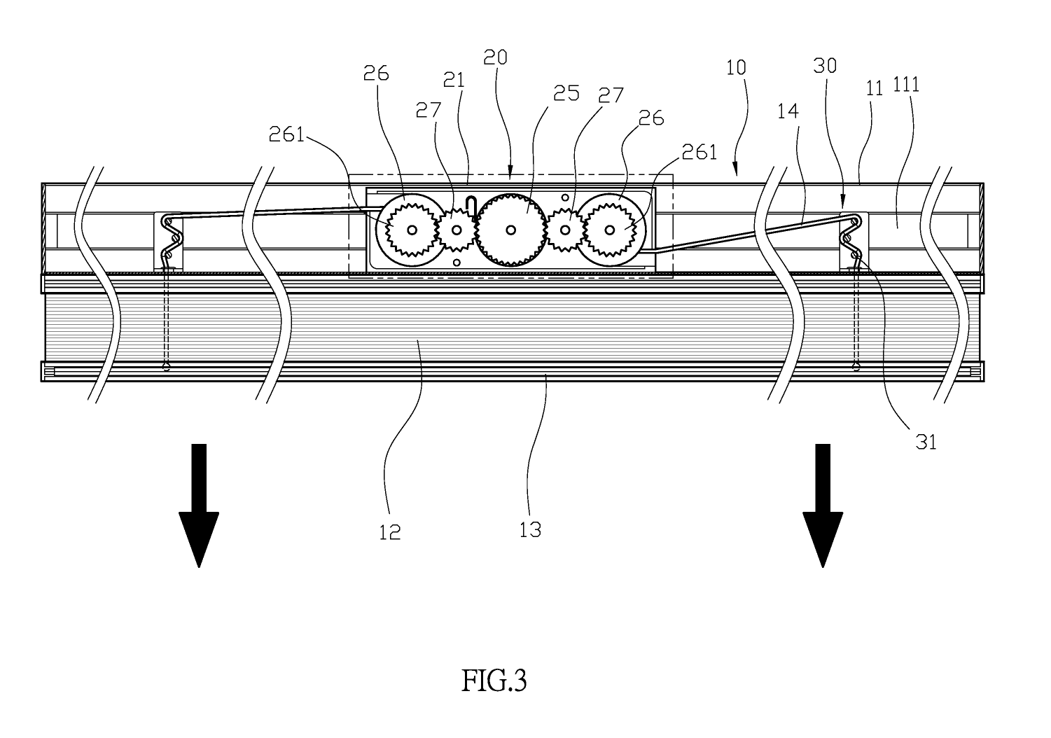

Referring to FIGS. 3 to 5, when the curtain body 10 is not used, the spring 24 of the string rolling mechanism 20 is in a relaxed status and the string 14 is collected in the rolling gears 26 on both sides of the spring 24. Also, the string 14 would not be pulled out because of the friction provided by the breaking units 30 on both sides of the string rolling mechanism 20. When the user wants to use the curtain 12, he/she can directly pull down the weighted lower beam 13 to unfold the curtain 12, and the string 14 would be simultaneously pulled out from the rolling gears 26 of the string rolling mechanism 20, so the two rolling gears 26 would rotate in opposite directions. The connecting gear 261 is further used to drive the gear 25 and the driving gear 27 to deform the spring 24 to a compression status through the shaft 251 of the gear 25. Meanwhile, when the user stops pulling down the curtain 12, two strings 14 are twined in the staggered rods 31 of the breaking unit 30, and when there is no external force pulling down the curtain 12, two strings 14 are directly interfered by the staggered rods 31 to reach a stopping status. Furthermore, the weight of the spring 24 and the weighted lower beam 13 is balanced to prevent the string 14 from restoring due to the resilient force of the spring 24, so the curtain 12 can be positioned when the user stop pulling it down.

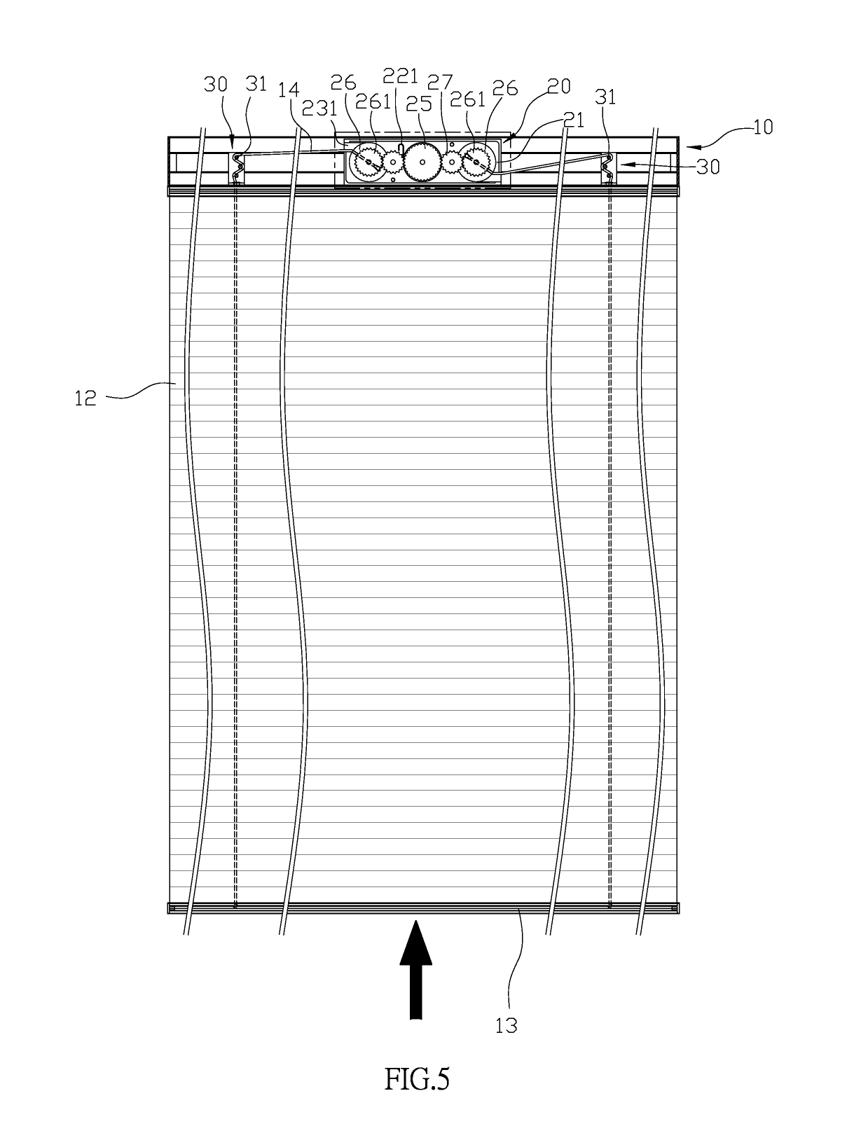

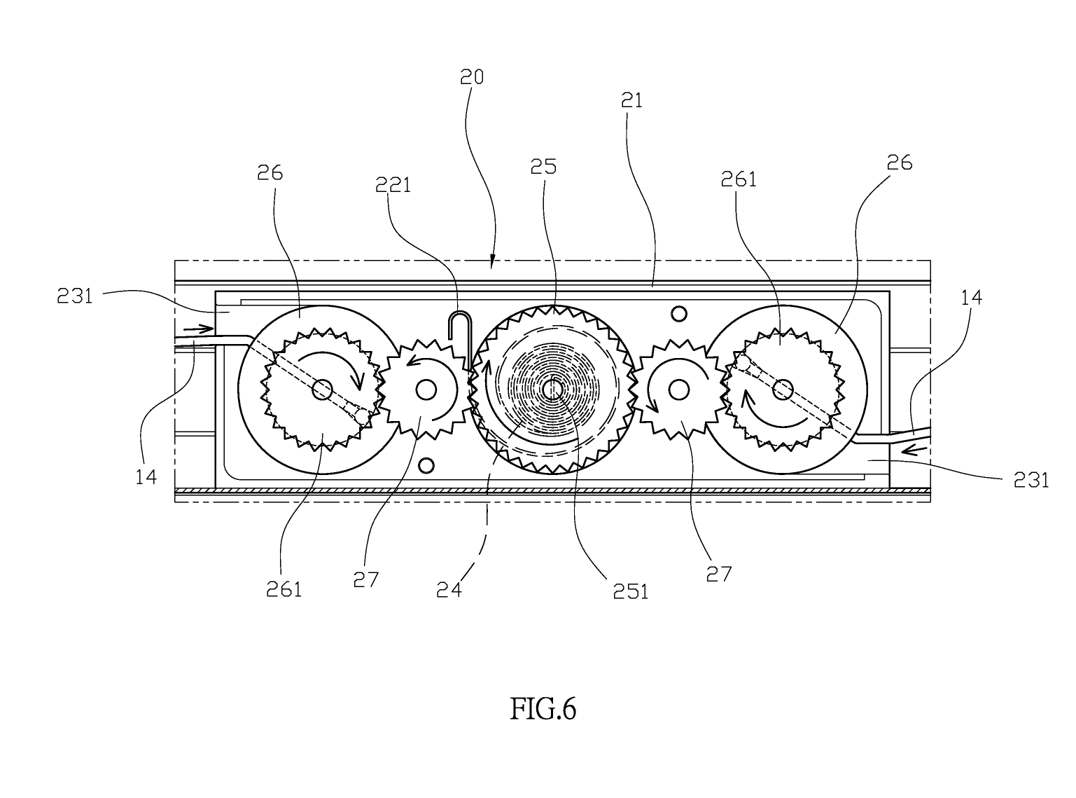

Furthermore, when the user wants to restore the curtain 12 to the curtain body 10, referring to FIGS. 5 and 6, he/she can push the weighted lower beam 13 up to retrieve the resilient force of the spring 24 to simultaneously drive the shaft 251 of the gear 25, the driving gear 27 and the connecting gear 261 of the rolling gear 26. So, the string 14 can be received in the rolling gear 26 of the string rolling mechanism 20, and the curtain 12 and the weighted lower beam 13 can be brought together when the string 14 is shortening. Also, when the user stops pushing the weighted lower beam 13, the staggered rods 31 of the breaking unit 30 provide friction to secure the string 14.

According to the embodiments described above, the present invention is advantageous because the weight of the spring 24 and the weighted lower beam 13 is balanced, the user can push/pull the weighted lower beam 13 to control the curtain 12 to eliminate the exposure of the string, so little children would not play with the string to lead to dangerous situation. Furthermore, the breaking unit 30 is disposed at each sides of the string rolling mechanism 20, so when the curtain 12 needs to be positioned, the friction between the string 14 and the breaking units 30 can be used to enhance the precision of the positioning of the curtain body 10.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A stringless curtain structure comprising:
a curtain body, having an upper beam including a receiving space, a curtain connected to a bottom portion of the upper beam, and a weighted lower beam disposed at a bottom portion of the curtain;
a string rolling mechanism disposed in the receiving space of the upper beam and having string to connect the curtain and being secured at a weighted lower beam, wherein the string rolling mechanism has a base having a base receiving space, and a string rolling space is located on both sides of the base receiving space, and a string opening is formed at an outer wall of the string rolling space, wherein a spring is disposed at the base receiving space of the base and a gear is disposed at center of the spring through a shaft, and a rolling gear is disposed at each of the string rolling spaces, and one end of string is secured at the rolling gear, and surface of the rolling gear has a connecting gear to drive the gear and a driving gear; and
two breaking units disposed on both sides of the receiving space of the upper beam, so the string is configured to be twined in the breaking unit from the string rolling mechanism, connected with the curtain and secured at the weighted lower beam.

2. The stringless curtain structure of claim 1, wherein a cover is provided to cover the base with the base receiving space and the string rolling space.

3. The stringless curtain structure of claim 1, wherein a conjugating portion is formed at one side of the base receiving space to secure and position the spring.

4. The stringless curtain structure of claim 1, wherein the breaking unit has at least three parallel staggered rods that are across each other.
